(19) United States
(12) Patent Application Publication
(10) Pub. No.: US 2012/0246136 A1
(43) Pub. Date: Sep. 27, 2012

(54) LIVE COMMUNICIATION ENABLED SEARCH ENGINE AND METHOD

(76) Inventor: Bryant MOSS, Nassau (BS)

(21) Appl. No.: 13/069,419

(22) Filed: Mar. 23, 2011

(51) Int. Cl. G06F 17/30

(52) U.S. Cl. 707/707; 707/E17.108

(57) ABSTRACT

A live communication-enabled search engine comprising: a user interface for receiving at least one query from the user and for the user to interact with the search engine; a query server for receiving the at least one query from a user; a corpus to which the query is applied and against which search results are provided to the user; and at least one communications module included in the search results, the communications module operatable by the user to communicate substantially live with a third party.

### FIELD AND BACKGROUND OF THE INVENTION

Embodiments of the current invention are related to searching hypermedia and cognitive resources on the internet, intranet, by using telecommunication signal technology. More specifically, embodiments of the present invention are directed to communication with intelligent cognitive resources and to improving the efficiency of analyzing search results and using the data gathered from efficient analysis to refine and optimize a search process in a live communication enabled search engine and method.

In the specification and claims which follow, the following terms are identified:
“search engine” is intended to mean a set of one or more algorithms which are directed, as known in the art, to provide results of accessible information. A search engine typically uses user inputs such as, but not limited to keyword input and mouse clicks. Examples of the use of search engines, in the framework of the definition hereinabove, include but are not limited to: google.com; yahoo.com; googlemaps.com; amazon.com; youtube.com; and other sets of one or more algorithms directed to providing results within a website/web page or across websites/web pages and/or documents. A search engine may be used to display results on one or more devices, such as, but not limited to: computer display; cellular phone display; video/television display; other visual displays; audible interface; voice activation; and a combination of any of the above. All of the devices noted hereinabove are included in the term “display device”.
“keyword” is intended to mean one or more words and/or a short phrase typically used as input for a search engine, as known in the art. Other forms of input, such as but not limited to: voice; handwriting; eye and head movement—serving a similar function as words and/or a short phrase are included in the meaning of “keyword” hereinbelow. The word “query” is used hereinbelow, in the context of user interacting with a search engine, in a substantially identical meaning as “keyword”.

Internet search engines, such as search portals, as known in the art, are typically found in well-known websites useful in searching the Internet for contextually relevant information beneficial to a user. Search engines employ technologies such as but no limited to: spiders; Boolean algorithms; page rank algorithms; and algorithms which are based on keyword density and the age of a domain name being searched. Document searches are frequently incorporated into search engine algorithm functionality to return more accurate and/or more comprehensive search results to the user. Additionally, search engines are employed within websites to provide, for example: help topics; product information; service information, etc.

Prior art search engines algorithms frequently use keyword input by the user. Typically, a search engine produces search results having results including URL links to other pages, as known in the art—all based on the input keyword. An example of a typical search result is 4 is shown in FIG. 1, which is a display representation showing a prior art search engine results page 4, following entry of a keyword. (Search engine results may not necessarily be limited to only one page, as known in the art.) Search engine results page 4 further contains: an administrative section 6; an organic results section 8; and an inorganic results section 12. Organic results section 8 further includes one or more organic results items 14 and inorganic results section 12 further includes one or more inorganic results items 15. Organic and inorganic results items 14 and 15, respectively, include, inter alia, a results URL address 16 and a results descriptive text 18.

Search engine algorithms are limited to displaying to the user historical, static data that has been indexed in the search engine network, such as inorganic and organic results items 14 and 15. The historical data is usually relevant and useful on an initial level; however historical data is frequently of limited use to a user who needs more intelligent information. Many efforts have been made to improve upon this historical, static situation.

Examples of prior art search engines and search engine algorithms include prior art listed hereinbelow.

U.S. Pat. No. 7,152,061 by Curtis et al., whose disclosure is incorporated herein by reference, describes methods and systems for providing a response to a user's query based on other users' picks. User responses are correlated to determine an affinity among users. User affinity is then used to modify the presentation of search results.

Ask.com, related to the assignee of the '061 patent hereinabove, located at 555 12th Street, Suite 500, Oakland, Calif. 94607, has an algorithm in which users ask questions and the search engine returns an answer. The Ask.com algorithm is limited to providing answers to questions based on historical data. Asking an additional question in effect begins another search.

U.S. Pat. Nos. 6,285,999 and 7,058,628 by Page, whose disclosures are incorporated herein by reference, describe a method which assigns importance ranks to nodes in a linked database, such as any database of documents containing citations, the world wide web or any other hypermedia database. The rank assigned to a document is calculated from the ranks of documents citing it. In addition, the rank of a document is calculated from a constant representing the probability that a browser through the database will randomly jump to the document. The method is particularly useful in enhancing the performance of search engine results for hypermedia databases, such as the world wide web, whose documents have a large variation in quality.

Manber et al., in U.S. Pat. No. 7,599,911, whose disclosure is incorporated herein by reference, describes a search system which provides search results to searchers in response to search queries and the search results are ranked. The ranking is determined by an automated ranking process in combination with human editorial input.

U.S. Pat. Nos. 5,836,771 and 5,934,910 by Ho et al., whose disclosures are incorporated herein by reference, describe a method and system to teach a user a subject based on his questions. The system allows the user to control his learning process, and helps to fill in gaps of misunderstand in the subject. The system, including a database, presents study materials on the subject to the user.

Mauldin, in U.S. Pat. No. 5,748,954, whose disclosure is incorporated herein by reference, describes a method of constructing a catalog of files stored on a network comprised of a plurality of interconnected computers each having a plurality of files stored thereon. The method is accomplished by establishing a queue containing at least one address representative of a file stored on one of the interconnected computers, ranking each address in the queue according to the popularity of the file presented by the address, downloading the file corresponding to the address in the queue having the highest ranking, processing the downloaded file to generate certain information about the downloaded file for the catalog, adding to the queue any addresses found in the downloaded file, and determining the popularity of file represented by the addresses in the queue according to how often a file is referenced by a computer other than the computer on which the file is stored.

U.S. Pat. No. 6,070,149 to Tavor et al., whose disclosure is incorporated herein by reference, describe a method for enabling users over a network or the internet to interact with an interactive sales representative for providing sales guidance. The system offers the user products, services, or ideas according to parameters collected from the user. The system guides the customer to retrieve the desired products. If the system does not have a product matched the customer requirement, it will operate a mechanism for suggesting alternatives which are the closest to the customer requirements. By guiding the customer to the target product, the system will shorten the search cycle for the customer.

Kirsch, in U.S. Pat. No. 5,659,732, whose disclosure is incorporated herein by reference, describes a document search method using a plurality of databases available from one or more servers using one or more search engines. For each database, the number of records is determined and reported, as well as frequency of search query term occurrences or hits, together with identification of database records corresponding to the hits. Reports from a plurality of databases are furnished to a user terminal, a client, where client software computes a relevance score for each record based upon the number of records in the database, the number of records having at least one hit and the number of hits for each record. This local computation from uniform data allows all documents to be ranked consistently as if coming from a single database.

U.S. Pat. No. 5,764,906 to Edelstein et al., whose disclosure is incorporated herein by reference, describes a universal electronic resource denotation, request and delivery system, which allows a user to locate information on a distributed computer system or network such as the Internet by knowing or guessing a short mnemonic alias of an electronic resource without the user having to know the physical or other location denotation such as the universal resource locator (URL) of the desired resource. The universal electronic resource denotation, request and delivery system supports a personal aliasing (nicknaming) feature, an additional features for finding location information such as URLs relating to a query term.

A major shortcoming of prior art search engines is that conventional hyper media search systems employ a spider or algorithm, which is dependent on a processor to execute instructions and to return relevant, accurate information to the user. Processors have capacity limits, and therefore search engine algorithms which depend on the processors are likewise subsequently limited.

The user has an underlying intention related to one or more a specific actions he intends to perform. When considering the dominant thought in the user's cognitive mind, a search result page serves as a “middle man” between the user's thought and the landing page to where the user can have an intention to perform a specific action or actions. Prior art search engine algorithms process keywords. However the algorithms do not possess the cognitive logic to associate classes of keywords and classes of actions suitable for the user to perform.

Typically one search engine result is equivalent to one IP address. Specifically, each search result typically comprises one page description, one cache page, one hyperlink, and advertisements. The cache page is located on the search engine hypermedia database—as shown in the prior art FIG. 1.

The cognitive mind, which comprehends a language and enables communication from one person to another, knows the structure and laws of a language. Language and words are divided into several classes, such as nouns, verbs, adjectives, pronouns, phrases, sentences, questions etc. The cognitive mind is aware that nouns and verbs are part of sentence structure. It is logical and practical to the structure of a language to understand the relationship between nouns, verbs, adverbs, adjectives etc. When a human speaks, he communicates to one or more people; those who understand the language and who likewise know the structure and laws of the language. If a person speaks without complying with the laws of the language, his words could be considered inappropriate and/or improper and, for example, they could be considered as slang by others listening to the speaker.

It is the nature of the cognitive mind to interact in live communication, such as by offering and receiving additional assistance and options that may have been initially unknown to the user. Offering assistance and options may be considered a goodwill gesture, or in the case of commerce, it is considered excellent customer service. Live communication should be extended in a search engine. Such live communication can be harnessed to present tools to the user for him to achieve desired, underlying results or actions.

Similarly, it is desirable for a search engine to respond to the user with options pertaining to other classes of actions; since the user is speaking a language to the search engine and the search engine responds. It is logical in live communication that the nature of the conversation between the user and the search engine that a conversation can be elevated/evolved into a “constructive” interaction.

There is therefore a need for a search engine to actively anticipate the need of a user to take action following display of a search result on a search result page and to provide the user with customer service and make or present actions/options to the user immediately while he is viewing the search results.

### SUMMARY OF THE INVENTION

According to the teachings of the present invention there is provided a live communication-enabled search engine comprising: a user interface for receiving at least one query from the user and for the user to interact with the search engine; a query server for receiving the at least one query from a user; a corpus to which the query is applied and against which search results are provided to the user; and at least one communications module included in the search results, the communications module operatable by the user to communicate substantially live with a third party. Preferably, the user interface includes at least one display device selected from the group containing: computer; telephone; video interface; and text messaging. Most preferably, the communications module further comprises at least one communications element selected from the group containing: chat; telephone; text messaging; voice activation; and video conference. Typically, the query server comprises a plurality of databases.

Most typically, the corpus includes at least one selected from the group containing: Internet; intranet, extranet, website, and at least one web page. Preferably, the third party is a person remotely locatable from the user, the person identifiable to interact directly with the user. Most preferably, the person further includes at least one chosen from the group containing a representative for: sales interaction, service assistance, technical support, corporate information; and public relations.

According to the teachings of the present invention there is further provided a method of live communication with a search engine comprising the steps of: using a user interface to receive at least one query from the user and for the user to interact with the search engine; configuring a query server for receiving the at least one query from a user; accessing a corpus to which the query is applied and against which search results are provided to the user; and operating at least one communications module included in the search results, the communication module operated by the user to communicate substantially live with a third party. Preferably, using a user interface includes at least one display device selected from the group containing: computer; telephone; video interface; and text messaging. Most preferably, operating at least one communications module comprises using at least one communications element selected from the group containing: chat; telephone; text messaging; voice activation; and video conference. Typically, the corpus includes at least one selected from the group containing: Internet; intranet, extranet, website, and at least one web page. Most typically, the third party is a person remotely located from the user, the person identified to interact directly with the user. Preferably, the person further includes at least one chosen from the group containing a representative for: sales interaction, service assistance, technical support, corporate information; and public relations.

### BRIEF DESCRIPTION OF THE DRAWINGS

The invention is herein described, by way of example only, with reference to the accompanying drawings, wherein:

FIG. 1 is a display representation showing elements of a prior art search engine results page following entry of a keyword;

FIGS. 2 and 3 are display representations showing elements of a live communications enabled search engine results page, following entry of a keyword, in accordance with an embodiment of the current invention;

FIG. 4 is a block diagram showing the relationship between a user and a query server, in accordance with an embodiment of the current invention;

FIG. 5 is a block diagram/flowchart further showing elements related to the communications with the query server of FIG. 4.

FIG. 6 is a combination flowchart/block diagram further detailing communication and interaction with the query server of FIG. 4, in accordance with embodiments of the current invention;

FIG. 7 is a flowchart showing communications between the user and a third party, in accordance with an embodiment of the current invention; and

FIGS. 8 and 9 are screen representations of a private webpage and a video content webpage having elements of a live communications enabled search engine, in accordance with an embodiment of the current invention.

### DETAILED DESCRIPTION OF PREFERRED EMBODIMENTS

The current invention relates to searching a hypermedia and cognitive resources on the internet, intranet, and through telecommunication signal technology. More specifically, embodiments of the present invention are directed to communication with intelligent cognitive resources and to improving the efficiency of analyzing search results and using the data gathered from efficient analysis to refine and optimize a search process in a live communication enabled search engine and method.

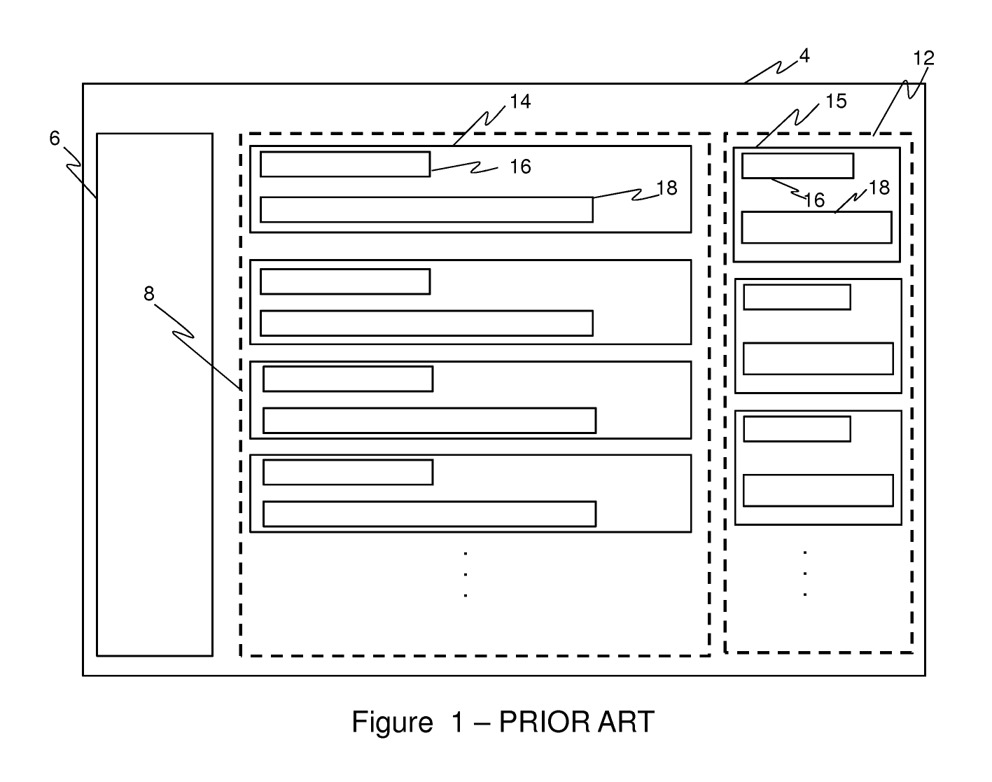

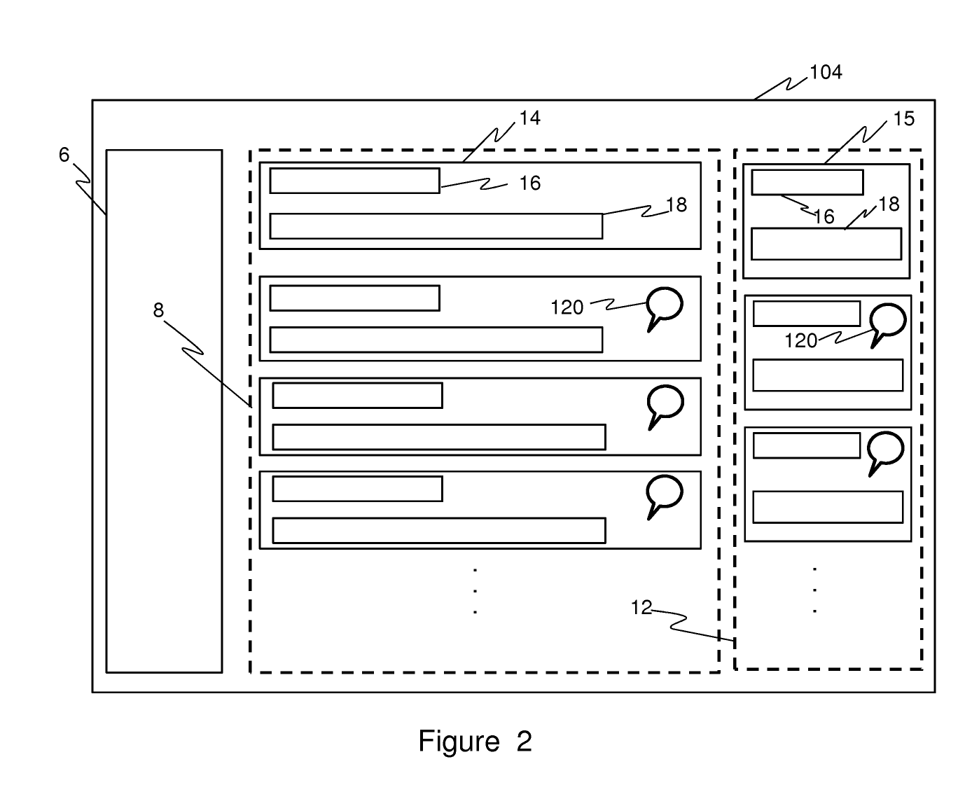

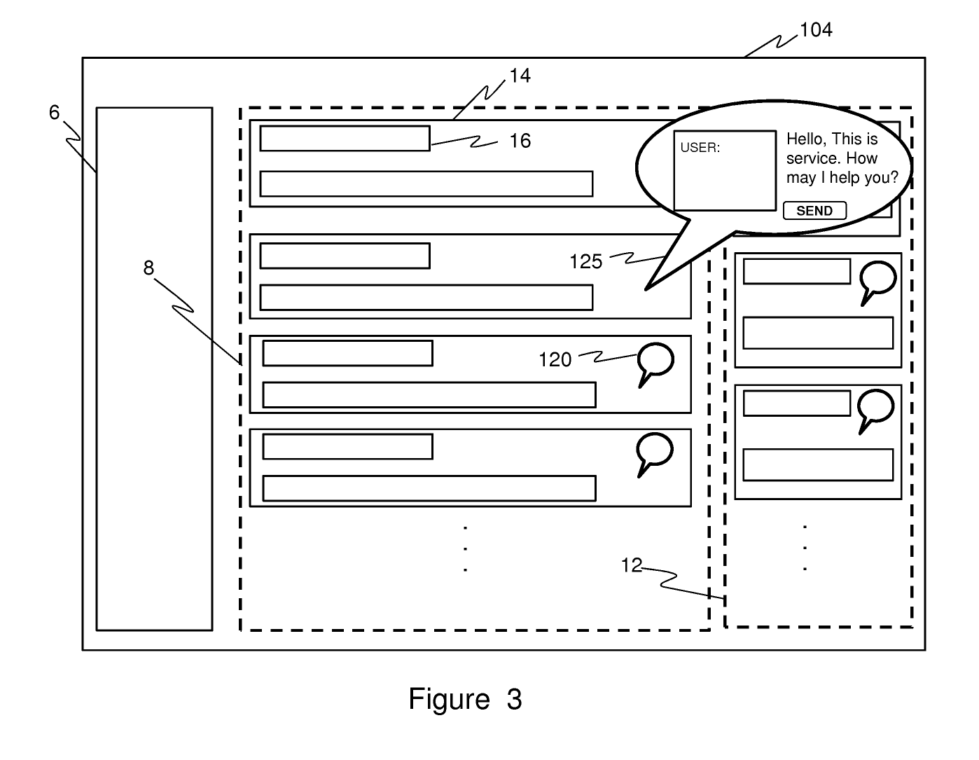

Reference is currently made to FIGS. 2 and 3, which are display representations showing a live communications enabled search engine results page 104, following entry of a keyword, in accordance with an embodiment of the current invention. Apart from differences described below, search engine results page 104 is identical in notation, configuration, and functionality to that shown in FIG. 1, and elements indicated by the same reference numerals and/or letters are generally identical in configuration, operation, and functionality as described hereinabove.

Live communications enabled search engine results page 104 is significantly differentiated from search engine results page 4 of FIG. 1 in that some organic and inorganic results items 14 and 15 further contain a communications module 120, which enables live communications as described hereinbelow. Communications module 120, when activated by the user, such as but not limited to using a mouse to point and click, as known in the art, opens communications element 125, as shown in FIG. 3. Communications element 125 enables interaction by the user directly from the search engine to a third party. It is noted, as shown in the FIGS. 2 and 3, that communications module 120 is not indicated in every results item, and this point is further discussed hereinbelow.

As described hereinabove, in an embodiment of the current invention the user communicates with a third party regarding, for example, a product. The user can express emotions, such as but not limited to: curiosity; persuasiveness; doubt; and bartering. Such complex human emotions cannot be fully and/or effectively interpreted by algorithms limited by processing power or by supercomputers that are excessively expensive and/or not practical for this application.

The exemplary communications element of FIG. 3 is a typical chat window, which opens when communications module 120 is activated. Direct communications is established between the user and a third party. The “third party” is a person remotely located from the user who represents the organization/company/webpage associated with organic and inorganic results items 14 and 15 and who has the role is to communicate directly with the user and address his interest in the specific results item. Examples of a typical third party are, but not limited to a representative for: sales interaction, service assistance, technical support, corporate information; and public relations. The third party and the user communicate directly with each another with the objective of immediately addressing the user's concern and question. In this way, a user's concern may be more immediately addressed while he is still viewing the search engine results. Delays, due to activities such as but not limited to: identifying a website and clicking through website sub-pages; copying down telephone information and placing a telephone call; and sending an email and waiting, are avoided.

In the specific example of sales conversions, when the third party is, for example, a sales representative, embodiments of the current invention serve to minimize the time between when targeted traffic (i.e. the user) lands on a webpage or a landing page until when he communicates with the sales representative, thus serving to convert targeted traffic into a sale. Targeted traffic from the search result page is directed through an intelligent sales communication with the sales representative, thus contributing to a higher sales conversion rate by not challenging the user's attention span, patience, or (for example) his willingness to invest more time navigating a webpage in search for additional targeted data related to keywords. Embodiments of the current invention serve to optimize a targeted action—for example a sales conversion.

The targeted action, which was traditionally accomplished remotely from the search engine, was traditionally not followed-up by the search engine nor its algorithms. Embodiments of the current invention enable performance of the targeted action while the user continues to interact with the search result page. This continuum of action and of information collection allows for additional behavior to be logged, enabling improvements in the search algorithms—as described hereinbelow.

Further extending the discussion of the exemplary case of sales and sales chat, today's sales chat technology is applicable only on a private webpage with private domains having search engine optimization, meta tags, and content optimized for the private website needs. Most private domains websites are connected to databases and not hypermedia databases. Embodiments of the current invention are applicable also to video content which is content displayed on the search result page and indexed by hypermedia databases. Additionally, embodiments of the current invention are applicable for private websites with domains—both as discussed hereinbelow.

It should be noted that whereas communications element 125 is shown in FIG. 3 (and in subsequent figures) to represent a “chat window”, any other method or mechanism that enables live communication between the user and the third party immediately following activation of communications module 120 is applicable, according to embodiments of the current invention. Such methods/mechanisms include, but are not limited to: telephone; video; and text messaging—or a combination of one or more of the above—by landline, cellular, VOIP, and/or internet streaming, for example.

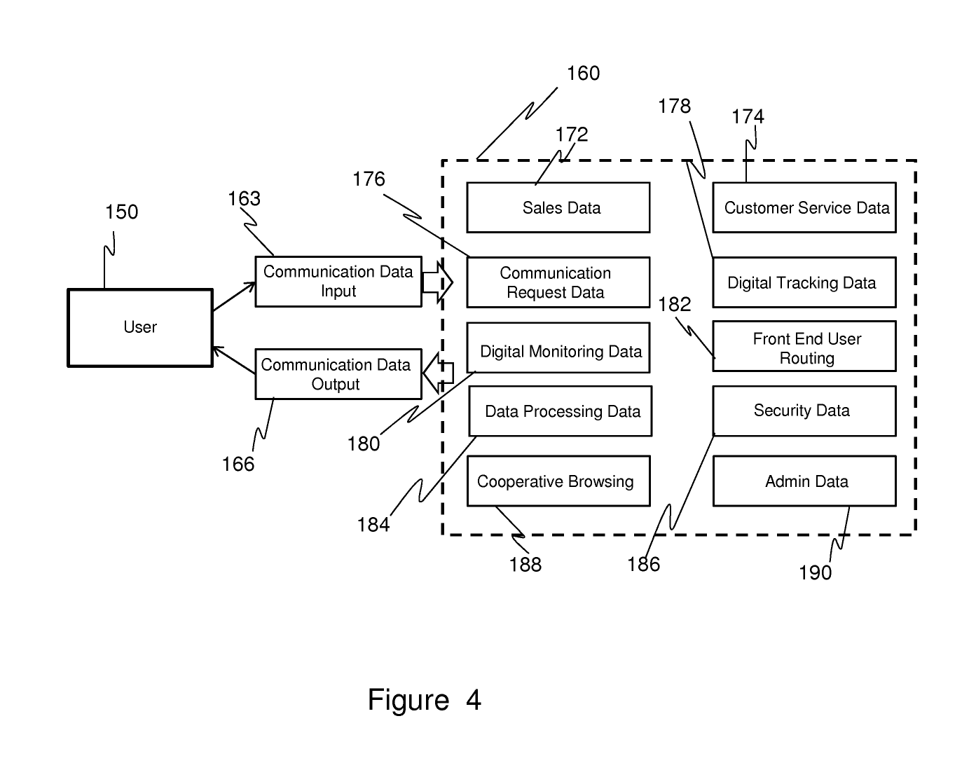

Reference is now made to FIGS. 4, 5, and 6, which are: a block diagram showing the relationship between a user 150 and a query server 160; a block diagram/flowchart further showing elements related to the communications with the query server; and a combination flowchart/block diagram further detailing communication and interaction with query server 160, respectively, in accordance with embodiments of the current invention. The query server contains a number of data bases, as described hereinbelow. As such, query server 160 is also referred to hereinbelow collectively as “the data base”. Communication data input 163 (frequently initiated by the user) and communication data output 166 (coming from the query server) interact with the user and query server, respectively. Query server 160 comprises: sales data 172, customer service data 174; communication request data 176; digital tracking data 178; digital monitoring data 180, front end user routing data 182; data processing data 184; security data 186, cooperative browsing data 188, and administrative data 190—all typical database elements of a query server.

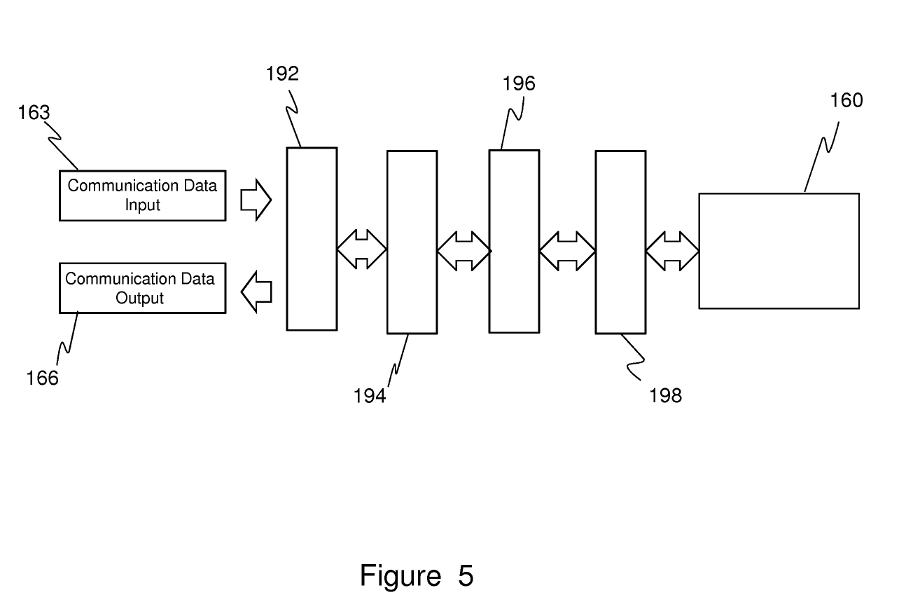

Furthermore, as shown in FIG. 5, communication data input 163 and communication data output 166 interact with query server 160 through a search engine network 192, a communication server 194, a hypermedia database 196, and a security server, for encryption, SSL, https, and for clients to communicate privately to the third party 198.

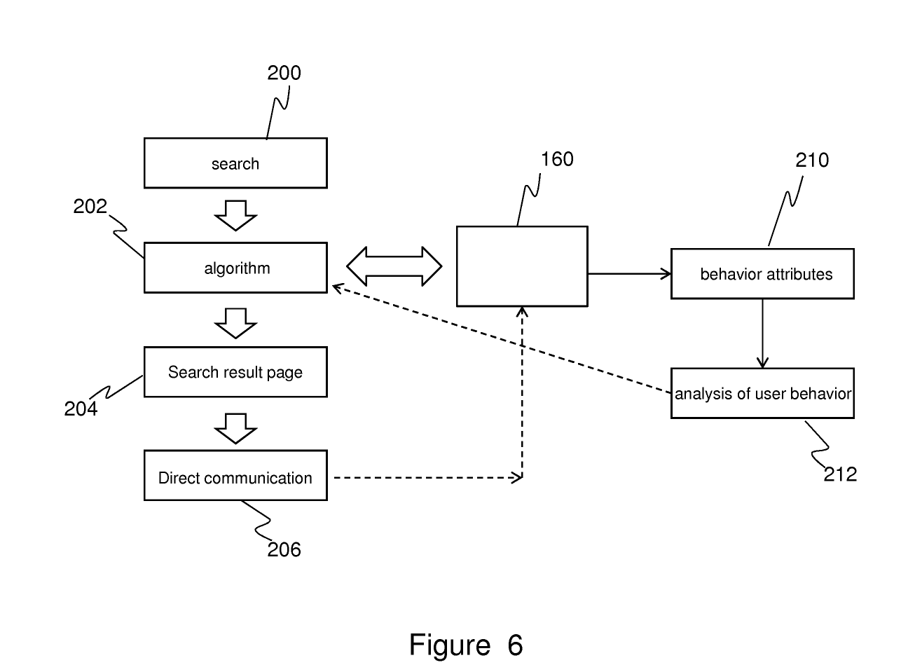

Additionally, as seen in FIG. 6, the flow of actions starts with the user (not shown in the figure) in search 200, thereby activating an algorithm 202, which in turn generates a search page result 204, which spawns a direct communication 204 (as described hereinabove, ref FIG. 3). Information from the direct communication is fed forward to the query server. Algorithm 202 interacts with query server 160, which also accesses information about user behavior attributes 210 and an analysis of user behavior 212—both obtained from previous user interactions and from the current user interaction. Information from analysis of user behavior 212 is fed back to the algorithm.

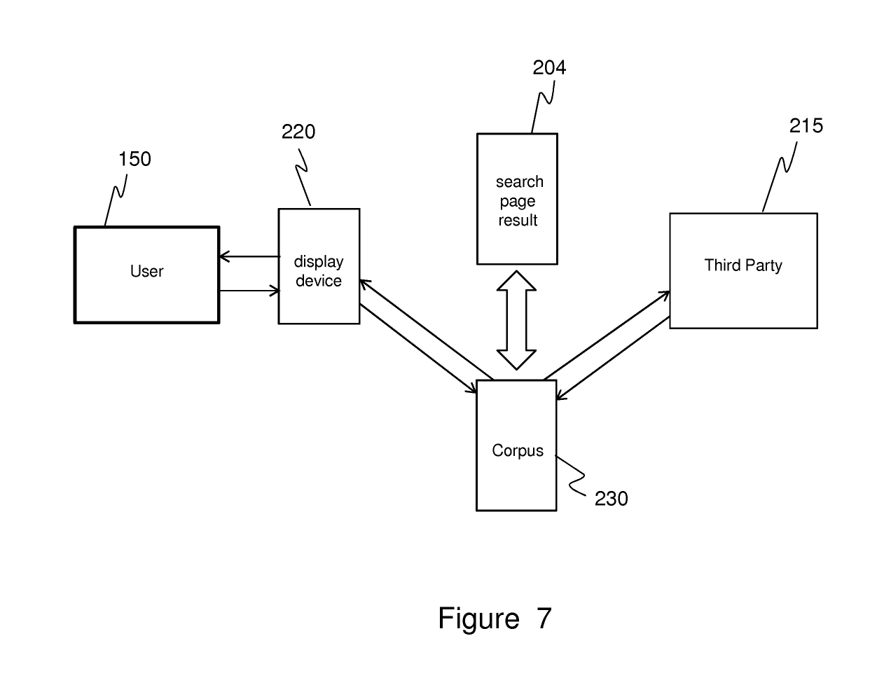

Reference is presently made to FIG. 7, which is a flowchart showing communications between the user and a third party 215, in accordance with an embodiment of the current invention. Apart from differences described below, user 150 and search page result 204 are identical in notation, configuration, and functionality to that shown in previous figures, and elements indicated by the same reference numerals and/or letters are generally identical in configuration, operation, and functionality as described hereinabove. User 150 interacts with a display device 220, which in turn interacts with a corpus 230. Corpus 230 is any repository of information, such as, but not limited to: intranet, extranet, website, and one or more individual web pages. Another example of corpus 230 is the internet. The Search page result 204 and third party 215 likewise interact with corpus 230, as known in the art.

Additionally, embodiments of the current invention aid the user by allowing him to perform targeted searches and targeted actions without leaving the search engine domain and without landing on a private domain. This in turn, further allows the user to conduct a plurality of queries and a plurality of actions without erasing the prior keyword search to re-enter a new keyword search.

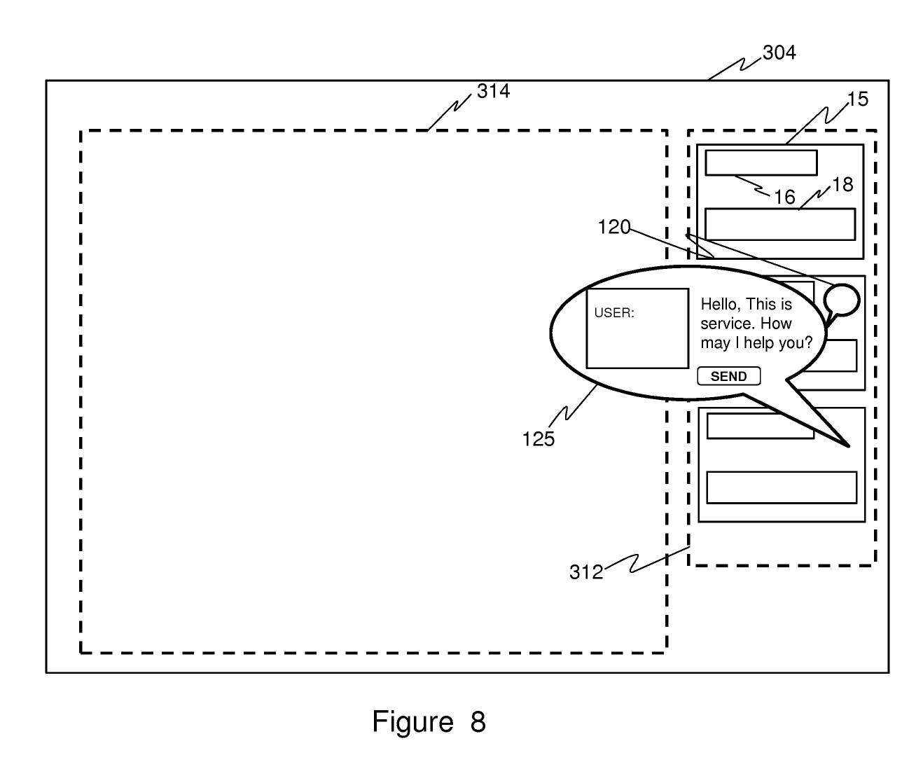

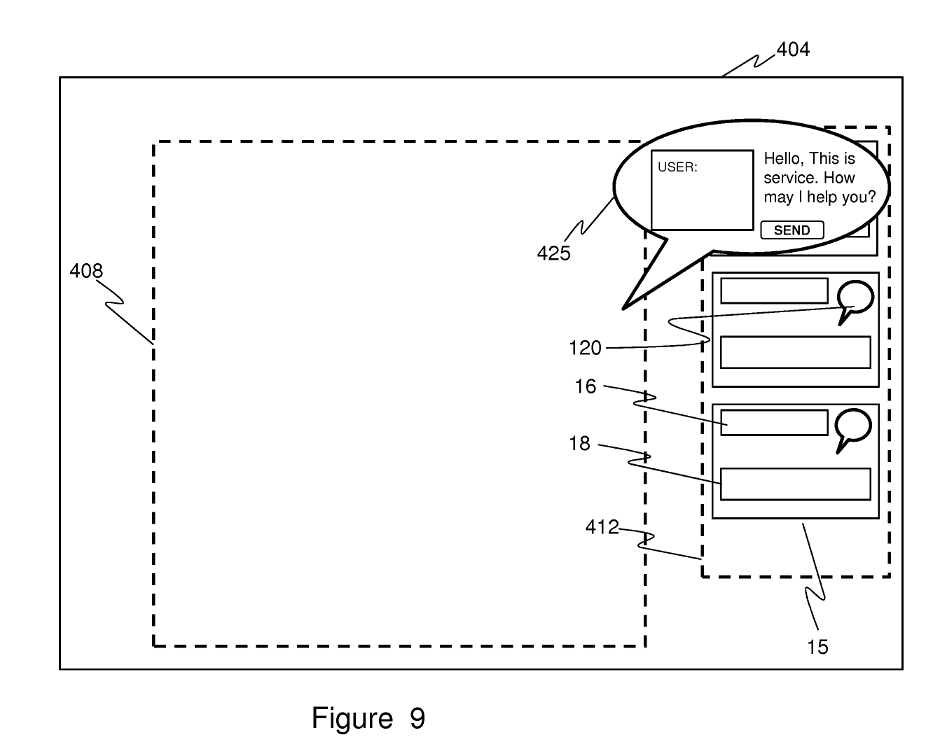

Reference is presently made to FIGS. 8 and 9, which are screen representations of a private webpage 304 and a video content webpage 404, respectively, having elements of a live communications enabled search engine, in accordance with an embodiment of the current invention. Apart from differences described below, inorganic results item 15, results URL address 16, results descriptive text 18, communications module 120, and communications element 125 are identical in notation, configuration, and functionality to that shown in FIGS. 2 and 3, and elements indicated by the same reference numerals and/or letters are generally identical in configuration, operation, and functionality as described hereinabove. Private web page 304 has private web page content 314 and video content webpage 404 has video content 408, as indicated in the respective figures.

Private web page 304 and video content webpage 404 have respective inorganic results sections 312 and 412, respectively, which are substantially generally identical in configuration, operation, and functionality as inorganic results section 12 of FIGS. 1-3, described hereinabove. Typically, inorganic results sections 312 and 412 are generated by similar—if not identical—mechanisms as described hereinabove for inorganic results section 12, meaning one more keywords are used to generate results from the corpus. As a result, inorganic results sections 312 and 412 are included the description of a search engine hereinabove, and communications module 120 and communications element 125 function as described hereinabove. Although not shown/emphasized in FIGS. 8 and 9, organic results, which correspond to private web page content 314 and video content 408, respectively, may likewise have communications element 125 functionality, as described hereinabove in FIGS. 2 and 3.

Video communications element 425 functions similarly to communications element 125—however it is activated by clicking directly on video content 408. Video communications element 425 is operable from a video player or a video skin which embodies the video (which respectively serve a similar function as communications module 120 in inorganic results section 412) to communicate with a third party, for example, to convert targeted traffic into sales while increasing sale conversion rate, as described hereinabove.

It will be appreciated that the above descriptions are intended only to serve as examples, and that many other embodiments are possible within the scope of the present invention as defined in the appended claims.

1. A live communication-enabled search engine comprising:
a user interface for receiving at least one query from the user and for the user to interact with the search engine;
a query server for receiving the at least one query from a user;
a corpus to which the query is applied and against which search results are provided to the user; and
at least one communications module included in the search results, the communications module operatable by the user to communicate substantially live with a third party.

2. The live search engine of claim 1, wherein the user interface includes at least one display device selected from the group containing: computer;
telephone; video interface; and text messaging.

3. The live search engine of claim 2, wherein the communications module further comprises at least one communications element selected from the group containing: chat; telephone; text messaging; voice activation; and video conference.

4. The live search engine of claim 3, wherein the query server comprises a plurality of databases.

5. The live search engine of claim 4, wherein the corpus includes at least one selected from the group containing: Internet; intranet, extranet, website, and at least one web page.

6. The live search engine of claim 5, wherein the third party is a person remotely locatable from the user, the person identifiable to interact directly with the user.

7. The live search engine of claim 6, wherein the person further includes at least one chosen from the group containing a representative for: sales interaction, service assistance, technical support, corporate information; and public relations.

8. A method of live communication with a search engine comprising the steps of:
using a user interface to receive at least one query from the user and for the user to interact with the search engine;
configuring a query server for receiving the at least one query from a user;
accessing a corpus to which the query is applied and against which search results are provided to the user; and
operating at least one communications module included in the search results, the communication module operated by the user to communicate substantially live with a third party.

9. The method of claim 8, whereby using a user interface includes at least one display device selected from the group containing: computer; telephone; video interface; and text messaging.

10. The method of claim 9, whereby operating at least one communications module comprises using at least one communications element selected from the group containing: chat; telephone; text messaging; voice activation; and video conference.

11. The method of claim 10, wherein the corpus includes at least one selected from the group containing: Internet; intranet, extranet, website, and at least one web page.

12. The method of claim 11, wherein the third party is a person remotely located from the user, the person identified to interact directly with the user.

13. The method of claim 12, wherein the person further includes at least one chosen from the group containing a representative for: sales interaction, service assistance, technical support, corporate information; and public relations.
